(19) United States
(12) Patent Application Publication
(10) Pub. No.: US 2026/0218095 A1
(43) Pub. Date: Jul. 30, 2026

(54) Method for Converting Alcoholic Lees into High-Quality Consumable Products with Enhanced Flavor and Health Benefits

(71) Applicants: Daniel Lee Dixon, Morgan hill, CA (US); William Andrew Brosseau, Morgan hill, CA (US)

(72) Inventors: Daniel Lee Dixon, Morgan hill, CA (US); William Andrew Brosseau, Morgan hill, CA (US)

(21) Appl. No.: 19/037,091

(22) Filed: Jan. 25, 2025

(51) Int. Cl. C12F 3/06; A23P 10/40; C12F 3/10

(52) U.S. Cl. CPC C12F 3/06; A23P 10/40; C12F 3/10

(57) ABSTRACT

The invention provides a method for converting alcoholic lees, a byproduct of winemaking, brewing, and distillation processes, into high-quality consumable products. The process involves collecting lees from sources such as wine, beer, whisky, brandy, and bourbon production, followed by purification through filtration, centrifugation, and washing. The lees may be optionally augmented with post-fermented or pre-fermented materials, as well as oak-derived compounds or tannins, to enhance nutritional content and flavor complexity. The purified lees are then dried using spray drying or freeze drying methods, ground into a fine powder, and optionally blended with tea leaves, herbs, or natural flavorings to create customizable products. The final product is packaged in food-grade, moisture-resistant materials and can be used for brewing beverages, culinary applications, or as a functional food ingredient. This method promotes sustainability by repurposing waste materials, offers health benefits through its bioactive compounds, and provides distinctive flavor profiles influenced by fermentation and barrel aging processes.

### BACKGROUND OF THE INVENTION

Alcoholic lees, the sediment left behind after fermentation and aging processes in the production of wine, beer, whisky, brandy, and other spirits, are often discarded as a waste byproduct. However, these lees are rich in valuable bioactive compounds, including antioxidants, polyphenols, amino acids, and vitamins, which are known to offer significant health benefits. Despite this, their potential for repurposing into consumable products has remained largely untapped.

In recent years, sustainability and waste reduction have become critical priorities in the food and beverage industry. Transforming byproducts such as lees into value-added products aligns with global efforts to minimize waste and maximize resource utilization. Additionally, the unique flavor profiles imparted by the fermentation and barrel-aging processes make alcoholic lees a promising ingredient for creating novel consumable products with distinctive sensory characteristics.

Traditional methods for processing lees often fail to preserve their nutritional and sensory attributes or lack scalability for commercial applications. There is a need for a comprehensive and efficient method to transform alcoholic lees into high-quality consumables, such as teas, powders, or culinary ingredients, while retaining their health benefits and enhancing their flavor profiles.

This invention addresses this need by providing a method that collects, purifies, augments, dries, and packages alcoholic lees into versatile consumable products. By incorporating optional materials such as post-fermented stems, skins, or grains, as well as oak-derived tannins from barrel-aging, the method creates customizable products that combine health benefits, sustainability, and unique flavor profiles.

### BRIEF SUMMARY OF THE INVENTION

The present invention provides a novel method for transforming alcoholic lees—the sediment byproduct of winemaking, brewing, and distillation processes—into high-quality consumable products. Lees, which are rich in antioxidants, polyphenols, and other bioactive compounds, are typically underutilized despite their nutritional and flavor potential. This method capitalizes on the natural health benefits and distinct sensory characteristics of lees, offering a sustainable solution to reduce waste in the beverage industry while creating valuable consumables.

The method begins with the collection of fresh, uncontaminated lees from wine (red or white), beer, whisky, brandy, or bourbon production. To enhance the nutritional content and flavor complexity, the lees can be optionally augmented with post-fermented materials such as grape skins, seeds, stems, or grains, as well as pre-fermented materials to balance composition. Oak-derived tannins or other compounds from barrel-aging processes may also be incorporated to further enrich the flavor profile.

Once the lees and optional augmenting materials are prepared, the purification process commences. This involves filtration to remove large particulates, centrifugation to separate solid and liquid components, and washing with distilled water to eliminate residual sugars, alcohol, and impurities. Following purification, the lees are subjected to a drying process, which may involve spray drying to create a fine powder or freeze drying to preserve sensitive bioactive compounds.

The dried lees are then milled into a uniform, fine powder to ensure consistency. Optionally, the powder may be blended with additional ingredients such as tea leaves, herbs, or natural flavorings to create customizable products tailored to consumer preferences. The resulting product is packaged in food-grade, moisture-resistant packaging to maintain freshness and prevent oxidation.

The consumable products created using this method are versatile and can be used to brew beverages, enhance culinary dishes, or serve as functional food additives. They offer a distinctive flavor profile reflective of the original fermentation and aging processes, along with numerous health benefits derived from the bioactive compounds naturally present in lees and optional augmenting materials.

This invention not only provides a sustainable solution for repurposing alcoholic lees but also creates high-value consumables with significant market potential, aligning with contemporary consumer demands for eco-conscious and health-focused products.

### DETAILED DESCRIPTION OF THE INVENTION

The present invention provides a comprehensive method for transforming alcoholic lees, a sediment byproduct of winemaking, brewing, and distillation, into high-quality consumable products. Lees are a rich source of bioactive compounds such as antioxidants, polyphenols, amino acids, and essential nutrients, making them highly beneficial for human consumption. However, their potential has been largely unutilized due to the lack of scalable and effective processing methods. This invention not only addresses these challenges but also offers an eco-conscious solution to reduce waste while creating value-added products.

The process begins with the collection of alcoholic lees from various sources, including wine (red or white), beer, whisky, brandy, and bourbon production. It is crucial to ensure that the lees are fresh and free from contaminants to preserve their nutritional properties. To enhance the flavor, texture, and bioactive content of the final product, the lees can be optionally augmented with post-fermented materials such as grape skins, seeds, stems, or grains. These materials are known for their complementary nutritional profiles and ability to improve the sensory characteristics of the product. Additionally, pre-fermented materials may be incorporated to balance the composition and optimize the overall quality. Oak-derived tannins or other compounds from barrel-aging processes may also be included to add complexity and depth to the flavor.

The purification process is a critical step in ensuring the quality and safety of the product. Filtration is performed first to remove large particulates, followed by centrifugation to separate solid and liquid components. The remaining material is then washed with distilled water to eliminate any residual sugars, alcohol, and impurities. This ensures that the purified lees retain their beneficial compounds while being free from unwanted contaminants.

Following purification, the lees are subjected to a drying process to convert them into a stable, powder form. Spray drying is one of the preferred methods, as it atomizes the purified lees and optional materials into a heated chamber, resulting in a fine powder. Alternatively, freeze drying can be employed to preserve temperature-sensitive bioactive compounds by sublimating ice under reduced pressure. The choice of drying method depends on the desired characteristics of the final product and the specific compounds to be preserved.

After drying, the lees are ground into a fine, uniform powder using milling techniques. This ensures consistency in the texture and enhances the usability of the product for various applications. Optionally, the powder can be blended with additional ingredients such as dried tea leaves, herbs, or natural flavorings. These optional additions allow for the creation of unique flavor profiles, influenced by the original fermentation and aging processes, and offer customizable options for different consumer preferences.

The final product is packaged in food-grade, moisture-resistant materials to preserve its freshness and prevent oxidation. Proper packaging ensures that the product remains stable during storage and retains its nutritional and sensory qualities over time.

The resulting consumable product can be used in a variety of applications. It is particularly suitable for brewing beverages, where steeping the product in hot water allows the extraction of its distinctive flavor and beneficial compounds. Additionally, the powder can be used as a functional ingredient in culinary dishes, baked goods, or dietary supplements. The flavor profile of the product reflects the unique characteristics of the original alcoholic lees, barrel-aging processes, and any optional augmenting materials.

This invention not only transforms an underutilized byproduct into a high-value consumable but also promotes sustainability by reducing waste in the beverage industry. By repurposing alcoholic lees into health-focused and eco-friendly products, this method meets the growing consumer demand for innovative and sustainable solutions. The combination of health benefits, distinctive flavors, and customizable options ensures that the invention has significant potential for commercial success in the food and beverage industry.

### BRIEF DESCRIPTION OF DRAWINGS

FIG. 1 represents the step-by-step process of transforming alcoholic lees into high-quality consumable products. Each stage of the process is depicted in sequence to visually explain the method described in the invention.

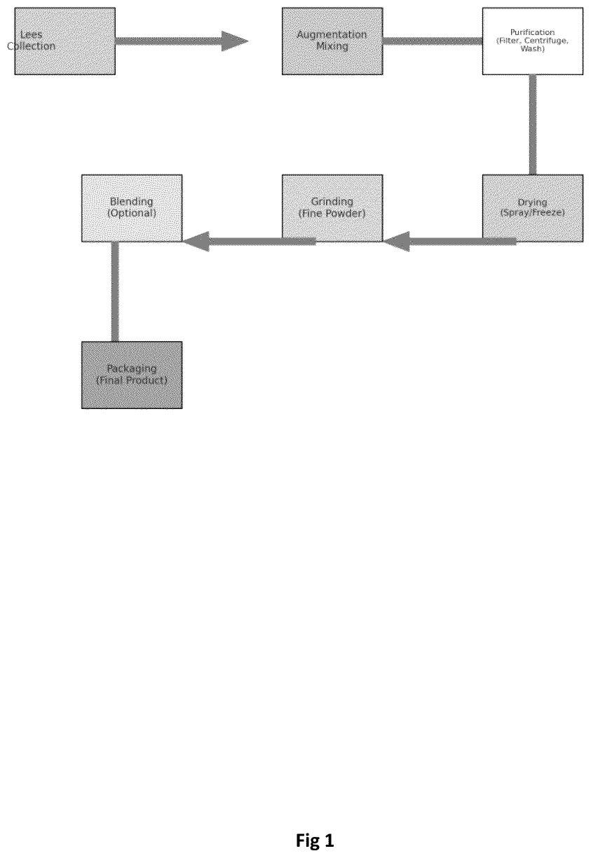

1. A method for producing a consumable product from alcoholic lees, comprising:
a. collecting lees from the production of alcoholic beverages;
b. optionally augmenting the lees with post-fermented materials, including stems, skins, seeds, or grains;
c. optionally augmenting the lees with pre-fermented materials to optimize composition;
d. purifying the lees by filtration, centrifugation, and washing;
e. drying the purified lees to form a powder;
f. grinding the dried product into a fine powder; and
g. packaging the powder as a consumable product.

2. The method of claim 1, wherein the drying step is performed using spray drying.

3. The method of claim 1, wherein the drying step is performed using freeze drying.

4. The method of claim 1, further comprising blending the powder with tea leaves, herbs, or natural flavorings.

5. The method of claim 1, wherein the lees are augmented with oak-derived compounds or tannins from the barrel-aging process.

6. A consumable product produced by the method of claim 1, characterized by a flavor profile reflective of fermentation and barrel aging.

7. The consumable product of claim 6, further comprising augmented post-fermented materials for enhanced bioactive content and flavor.

8. The consumable product of claim 6, wherein optional pre-fermented materials are added to optimize composition.

9. The consumable product of claim 6, further blended with herbs or natural flavorings to enhance aroma and taste.

10. The consumable product of claim 6, wherein the powder is used for brewing beverages or culinary applications.
